(19) United States
(12) Patent Application Publication
(10) Pub. No.: US 2015/0236391 A1
(43) Pub. Date: Aug. 20, 2015

(54) FOAMED-METAL COMPONENTS FOR WIRELESS-COMMUNICATION TOWERS

(71) Applicant: Dow Global Technologies LLC, Midland, MI (US)

(72) Inventor: Mohamed Esseghir, Collegeville, PA (US)

(21) Appl. No.: 14/421,243

(22) PCT Filed: Sep. 12, 2013
(86) PCT No.: PCT/US13/59389

§ 371 Date: Feb. 12, 2015

Related U.S. Application Data
(60) Provisional application No. 61/707,075, filed on Sep. 28, 2012.

(51) Int. Cl. H01P 1/207; C22C 21/00; B32B 15/01; C22C 1/08; C22C 1/10; C08K 3/08; C22C 23/00

(52) U.S. Cl. CPC H01P 1/207; C08K 3/08; C22C 21/00; C22C 23/00; C22C 1/08; C22C 1/10; B32B 15/01

(57) ABSTRACT

A wireless-communications-tower component being at least partially formed from a foamed metal. The foamed metal has a density of less than 2.7 g/cm³, a thermal conductivity greater than 1 W/m·K, and a coefficient of thermal expansion of less than 30 μm/m·K. Such a foamed metal can be an open-cell foamed metal or a closed-cell foamed metal. Foamed metal components can also present a non-foamed or polymer-coated surface.

### REFERENCE TO RELATED APPLICATIONS

The present application claims the benefit of U.S. Provisional Application No. 61/707,075, filed on Sep. 28, 2012.

### FIELD

Various embodiments of the present invention relate to metal-based components for use on wireless-communication towers.

### INTRODUCTION

In the telecommunications field, it is expected that bandwidth demand will increase annually across the world to support new services and increased numbers of users, thus shifting wireless systems to higher frequency bands. There is a trend in the industry to move base-station electronics from the tower base to the upper regions of wireless-communications towers (i.e., tower-top electronics); this is an effort to reduce signal losses in telecommunication cables connecting the tower top to the base equipment. As increasing numbers of components are moved up the tower, the weight of such components becomes a concern.

### SUMMARY

One embodiment is an apparatus, comprising:
a wireless-communications-tower component being at least partially formed from a foamed metal,
wherein said foamed metal has a density of less than 2.7 grams per cubic centimeter (“g/cm³”) measured at 25° C.

### DETAILED DESCRIPTION

Various embodiments of the present invention concern a wireless-communications-tower component being at least partially formed from a metal-based material. Such a metal-based material can have certain properties making it suitable for tower-top applications, including certain ranges for density, thermal conductivity, and coefficient of thermal expansion, among others. Such wireless-communications-tower components can include radio frequency (“RF”) cavity filters, heat sinks, enclosures, tower-top support accessories, and combinations thereof, among others.

### Metal-Based Material

As just noted, the wireless-communications-tower component can be at least partially formed from a metal-based material. As used herein, “metal-based” materials are materials comprising metal as a major (i.e., greater than 25 weight percent (“wt %”)) component. In various embodiments, the metal-based material can comprise one or more metals in a combined amount of at least 50, at least 60, at least 70, at least 80, at least 90, or at least 95 wt %. In some embodiments, one or more metals constitute all or substantially all of the metal-based material. As used herein, the term “substantially all” denotes a presence of non-described components of less than 10 parts per million (“ppm”) individually. In alternate embodiments, the metal-based material can be a composite of metal with one or more fillers, as described in greater detail below, and may thus comprise one or more metals in lower proportions (e.g., from as low as 5 wt % up to 99 wt %).

The metal component of the metal-based material can be any metal or combination of metals (i.e., metal alloy) known or hereafter discovered in the art. In various embodiments, the metal-based material can comprise a low-density metal, such as aluminum or magnesium, or other metals such nickel, iron, bronze, copper and their alloys. In one or more embodiments, the metal-based material can comprise a metal alloy, such as aluminum or magnesium and their alloys. In certain embodiments, the metal-based material comprises aluminum. In various embodiments, aluminum constitutes at least 50, at least 60, at least 70, at least 80, at least 90, at least 95 wt %, substantially all, or all of the metal component of the metal-based material. Accordingly, in various embodiments, the metal-based material can be an aluminum-based material. Additionally, the aluminum employed can be an aluminum alloy, such as AA 6061. Alloy 6061 typically contains 97.9 wt % aluminum, 0.6 wt % silicon, 0.28 wt % copper, 1.0 wt % magnesium, and 0.2 wt % chromium.

As noted above, the metal-based material can have certain properties. In various embodiments, the metal-based material has a density of less than 2.7, less than 2.6, less than 2.5, less than 2.4, less than 2.3, less than 2.2, less than 2.1, or less than 2.0 grams per cubic centimeter (“g/cm³”). In such embodiments, the metal-based material can have a density of at least 0.1 g/cm³. Since the metal-based material can include polymer-metal composites, as discussed below, density values provided herein can be measured at 25° C. in accordance with ASTM D792. For non-polymer/metal-composite materials, density can be determined according to ASTM D1505 by density gradient method.

In various embodiments, the metal-based material has a thermal conductivity of greater than 1, greater than 2, greater than 3, greater than 4, greater than 5, or greater than 6 watts per meter Kelvin (“W/m·K”). In such embodiments, the metal-based material can have a thermal conductivity no more than 50, or no more 100, no more than 180, or no more than 250 W/m·K. All thermal conductivity values provided herein are measured at 25° C. according to according to ISO 22007-2 (the transient plane heat source [hot disc]method). In various embodiments, the metal-based material has a linear, isotropic coefficient of thermal expansion (“CTE”) of less than 50, less than 45, less than 40, less than 35, less than 30, or less than 26 micrometers per meter Kelvin (“μm/m·K,” which is equivalent to ppm/° C.). In such embodiments, the metal-based material can have a CTE of at least 10 μm/m·K. All CTE values provided herein are measured according to the procedure provided in the Test Methods section, below.

In various embodiments, the metal-based material has a tensile strength of at least 5.0 megapascals (“MPa”). In such embodiments, the metal-based material can have an ultimate tensile strength generally no greater than 500 MPa. Since the metal-based material described herein also relates to polymer-metal composites, all tensile strength values provided herein are measured according to ASTM D638. For metal-only samples, measure tensile properties according to ASTM B557M.

In various embodiments, the metal-based material can be a foamed metal. As used herein, the term “foamed metal” denotes a metal having a cellular structure comprising a volume fraction of void-space pores. The metal of the foamed metal can be any metal known or hereafter discovered in the art as being suitable for preparing a foamed metal. For example, the metal of the foamed metal can be selected from aluminum, magnesium, and copper, amongst others and their alloys. In certain embodiments, the foamed metal can be a foamed aluminum.

In various embodiments, the foamed metal can have a density ranging from 0.1 to 2.0 g/cm³, from 0.1 to 1.0 g/cm³, or from 0.25 to 0.5 g/cm³. In some embodiments, the foamed metal can have a relative density of from 0.03 to 0.9, from 0.1 to 0.7, or from 0.14 to 0.5, where the relative density (dimensionless) is defined as the ratio of the density of the foamed metal to that of the base metal (i.e., a non-foamed sample of an otherwise identical metal). Additionally, the foamed metal can have a thermal conductivity ranging from 5 to 150 W/m·K, from 8 to 125 W/m·K, or from 15 to 80 W/m·K. Furthermore, the foamed metal can have a CTE ranging from 15 to 25 μm/m·K, or from 19 to 23 μm/m·K. In various embodiments, the foamed metal can have a tensile strength ranging from 5 to 500 MPa, from 20 to 400 MPa, from 50 to 300 MPa, from 60 to 200 MPa, or from 80 to 200 MPa.

In various embodiments, the foamed metal can be a closed-cell foamed metal. As known in the art, the term “closed-cell” denotes a structure where the majority of void-space pores in the metal-based material are isolated pores (i.e., not interconnected with other void-space pores). Closed-cell foamed metals can generally have cell sizes ranging from 1 to 8 millimeters (“mm”).

In various embodiments, the foamed metal can be an open-cell foamed metal. As known in the art, the term “open-cell” denotes a structure where the majority of void-space pores in the metal-based material are interconnected pores (i.e., in open contact with one or more adjacent pores). Open-cell foamed metals can generally have cell sizes ranging from 0.5 to 10 mm.

Commercially available foamed metals may be employed in various embodiments described herein. For instance, suitable foamed aluminum materials can be obtained from Isotech Inc, in either sheeted or 3-Dimensional cast form. Such materials can also be obtained from Foamtech™ Corporation, Racemat™ BV, and Reade™ International Corporation, each in sheet form.

In various embodiments, particularly when an open-cell foamed metal is employed, the foamed metal can present a surface region or a portion of a surface region that is either (a) non-foamed metal, or (b) coated with a polymer-based material. In such embodiments, the foamed metal can thus present a surface that is free or substantially free of defects (i.e., smooth). Such surfaces can facilitate metal plating and permit formation of components where smooth surfaces are desired, such as the case of heat sink fins, where the desired strength may not be achieved with a foamed structure alone. In addition, being of such thickness, fins do not generally add substantial weight to the construction, thus it may be desirable to retain a non-foamed structure or fill (or at least partially fill) the void-space pores of the foamed structure with a polymer-based material for added strength. When a surface region is non-foamed, the non-foamed portion can have an average depth from the surface in the range of from 0.05 to 5 mm. An example of a suitable foamed metal having a non-foamed surface region is stabilized aluminum foam, commercially available from Alusion™, a division of Cymat Technologies, Toronto, Canada.

Additional approaches to improve thermal dissipation of the foamed metal can be, for example, the use of air passages through the foamed core to enable air circulation without affecting the overall performance of the article, such as retaining a sealed enclosure to protect enclosed components. This approach is particularly useful in the case where non-foamed outer layers are used, i.e., where the circulation occurs only in the core via judiciously placed channels.

When a polymer-based material is employed to provide a defect-free or substantially defect free surface, or to fill or at least partially fill the foamed structure for additional strength, such polymer-based material can be applied in a thickness ranging from 0.05 mm to fully penetrating the foamed metal to form an interpenetrating polymer-metal network. Examples of polymer-based materials for use in these embodiments include thermoset epoxies, or thermoplastic amorphous or crystalline polymers. In an embodiment, the polymer-based material is a thermoset epoxy. Polymer-based materials can be applied to a surface region, or made to penetrate inside the structure of the foamed metal using any conventional or hereafter discovered methods in the art. For example, such application can be achieved via vacuum casting or pressure impregnation, or insert molding with a thermoplastic material under pressure. The polymer materials can themselves be filled with appropriate fillers for density reduction, heat strength, and/or thermal conductivity enhancements. Such fillers may include silica, quartz, alumina, boron nitride, aluminum nitride, graphite, carbon black, carbon nanotubes, aluminum flakes and fibers, glass fibers, glass or ceramic microspheres, and combinations or two or more thereof.

In various embodiments, the metal-based material can be a microsphere-filled metal. As used herein, the term “microsphere” denotes a filler material having a mass-median-diameter (“D50”) of less than 500 micrometers (“μm”). Microsphere fillers suitable for use herein can generally have a spherical or substantially spherical shape. The metal of the microsphere-filled metal can be any metal described above. As noted above, the metal of the metal-based material can be aluminum. Accordingly, in certain embodiments, the microsphere-filled metal can be a microsphere-filled aluminum.

In various embodiments, the microsphere-filled metal can have a density ranging from 0.6 to 2 g/cm³. Additionally, the microsphere-filled metal can have a thermal conductivity ranging from 5 to 150 W/m·K. Furthermore, the microsphere-filled metal can have a linear, isotropic CTE ranging from 8 to 25 μm/m·K. In various embodiments, the microsphere-filled metal can have a tensile strength ranging from 0.8 to 60 Kpsi (˜5.5 to 413.7 MPa).

Various types of microsphere fillers can be employed in the microsphere-filled metals suitable for use herein. In various embodiments, the microsphere fillers are hollow. Additionally, in certain embodiments, the microspheres can be selected from the group consisting of glass microspheres, mullite microspheres, alumina microspheres, alumino-silicate microspheres (a.k.a., cenospheres), ceramic microspheres, silica-carbon microspheres, carbon microspheres, and mixtures of two or more thereof.

In various embodiments, microspheres suitable for use herein can have a particle size distribution D10 of from 8 to 30 μm. Additionally, the microspheres can have a D50 of from 10 to 70 μm. Furthermore, the microspheres can have a D90 of from 25 to 120 μm. Also, the microspheres can have a true density ranging from 0.1 to 0.7 g/cm³. As known in the art, “true” density is a density measurement that discounts inter-particle void space (as opposed to “bulk” density). The true density of the microspheres can be determined with a helium gas substitution type dry automatic densimeter (for example, Acupic 1330, by Shimadzu Corporation) as described in European Patent Application No. EP 1 156 021 A1. In addition, microspheres suitable for use herein can have a CTE ranging from 0.1 to 8 μm/m·K. Also, microspheres suitable for use can have a thermal conductivity ranging from 0.5 to 5 W/m·K. The microspheres can also be metal coated.

In various embodiments, the microspheres can constitute in the range of from 1 to 95 volume percent (“vol %”), from 10 to 80 vol %, or from 30 to 70 vol %, based on the total volume of the microsphere-filled metal.

In one or more embodiments, the microspheres can optionally be combined with one or more types of conventional filler materials. Examples of conventional filler materials include silica and alumina.

Commercially available microsphere-filled metals may be employed in various embodiments described herein. An example of one such commercially available product is SComP™ from Powdermet Inc., Euclid, Ohio, USA

In various embodiments, the microsphere-filled metal can present a surface region or a portion of a surface region that is either (a) non-microsphere-filled metal, or (b) coated with a polymer-based material. In such embodiments, the microsphere-filled metal can thus present a surface that is free or substantially free of defects (i.e., smooth), which can facilitate metal plating and allow formation of components where smooth surfaces are desired (e.g., heat sink fins). When a surface region is non-microsphere-filled, the non-microsphere-filled portion can have an average depth from the surface in the range of from 0.2 to 5 mm.

When a polymer-based material is employed to provide a defect-free surface, such polymer-based material can be applied in a thickness ranging from 50 to 1,000 μm. Examples of and methods for using polymer-based materials for use in these embodiments are the same as described above with reference to the foamed metal.

### Wireless-Communications-Tower Components

As noted above, any one or more of the above-described metal-based materials can be employed to produce, at least in part, a wireless-communications-tower component. As used herein, “wireless-communications-tower component” denotes any piece of electronic communications equipment, global positioning system (“GPS”) equipment, or similar equipment, or a part or portion thereof. Although the term “tower” is employed, it should be noted that such equipment need not actually be mounted or designed to be mounted on a tower, rather, other elevated locations such as radio masts, buildings, monuments, or trees may also be considered. Examples of such components include, but are not limited to, antennas, transmitters, receivers, transceivers, digital signal processors, control electronics, GPS receivers, electrical power sources, and enclosures for electrical component housing. Additionally, components typically found within such electrical equipment, such as RF filters and heat sinks, are also contemplated. Furthermore, tower-top support accessories, such as platforms and mounting hardware, are also included.

As noted above, the wireless-communications-tower component can be an RF filter. An RF filter is a key element in a remote radio head. RF filters are used to eliminate signals of certain frequencies and are commonly used as building blocks for duplexers and diplexers to combine or separate multiple frequency bands. RF filters also play a key role in minimizing interference between systems operating in different bands.

An RF cavity filter is a commonly used RF filter. A common practice to make these filters of various designs and physical geometries is to die cast aluminum into the desired structure or machine a final geometry from a die cast pre-form. RF filters, their characteristics, their fabrication, their machining, and their overall production are described, for example, in U.S. Pat. Nos. 7,847,658 and 8,072,298.

As noted above, a polymer-based material can be employed to provide a smooth surface on the metal-based material and/or as a filler for the metal-based material. For example, epoxy composite materials can be employed to coat at least a portion of the surface of the metal-based material. Exemplary epoxy composites are described in U.S. Provisional Patent Application Ser. No. 61/557,918 (“the '918 application”). Additionally, the surface of the metal-based material and/or the polymer-based material can be metalized, such as described in the '918 application.

In various embodiments, at least a portion of the above-described metal-based material can be metal plated, as is typically done for RF cavity filters. For example, a metal layer such as copper, silver, or gold can be deposited on the metal-based material, or intervening polymer-based material layer, via various plating techniques. Examples of suitable plating techniques can be found, for example, in the '918 application.

In an embodiment, the wireless-communications-tower component can be a heat sink. As known in the art, heat sinks, which can be a component employed in remote radio heads, typically comprise a base member and a heat spreading member (or “fins”). The heat spreading member is typically formed from a high conductivity material, such as copper. In an embodiment, heat sinks fabricated according to the present description can comprise a base member formed from any of the above-described metal-based materials, while employing a conventional heat spreading member. In various embodiments, when a foamed metal is employed (particularly an open-cell foamed metal), the base member can have a non-foamed surface as described above.

In various embodiments, the wireless-communications-tower component can be an enclosure that contains and/or protects electronic equipment. Examples of such enclosures can be, for example, an MRH-24605 LTE Remote Radio Head from MTI Inc.

In one or more embodiments, the wireless-communications-tower component can be a support member, such as fastening brackets or components used in making platforms. Specific components include, but are not limited to, antenna mounts, support brackets, co-location platforms, clamp systems, sector frame assemblies, ice bridge kits, tri-sector t-mount assemblies, light kit mounting systems, and wave-guide bridges.

Fabricating the above-described wireless-communications-tower component from the metal-based materials described herein can be performed according to any known or hereafter-discovered metal-working techniques, such as forming, bending, die-casting, machining, and combinations thereof.

### Test Methods

### Density

Density for composite samples is determined at 25° C. in accordance with ASTM D792. For metal-only samples, determine density according to ASTM D1505 by density gradient method.

### Thermal Conductivity

Thermal conductivity is determined according to ISO 22007-2 (the transient plane heat source (hot disc) method).

### Coefficient of Thermal Expansion

CTE is determined using a Thermomechanical Analyzer (TMA 2940 from TA Instruments). An expansion profile is generated using a heating rate of 5° C./minute, and the CTE is calculated as the slope of the expansion profile curve as follows: CTE=ΔL/(ΔT×L) where ΔL is the change in sample length (μm), L is the original length of the sample (m) and ΔT is the change in temperature (° C.). The temperature range over which the slope is measured is 20° C. to 60° C. on the second heat.

### Tensile Strength

Tensile property measurements (tensile strength and % elongation at break) are made on the cured epoxy formulation according to ASTM D638 using a Type 1 tensile bar and strain rate of 0.2 inch/minute. For aluminum metal samples, measure tensile properties according to ASTM B557M.

### Glass Transition Temperature (Tg)

Measure Tg by placing a sample in a differential scanning calorimeter (“DSC”) with heating and cooling at 10° C./minute at a first heating scan of from 0 to 250° C. to a second heating scan of from 0 to 250° C. Tg is reported as the half-height value of the 2nd order transition on the second heating scan of from 0 to 250° C.

### EXAMPLES

### Example 1

### Materials Comparison

A sample of foamed aluminum (S1) is compared to conventional aluminum (Comp. A), three epoxy composite compositions (Comp. B-D), and a glass-filled polyetherimide (Comp. E) in Table 1, below. The foamed aluminum is a 25.4 mm thick sample having a density of 0.41 g/cm³ and a primarily open-cell structure obtained from Cymat Technologies, Ltd. The conventional aluminum is aluminum alloy 6061. The mixing, casting, and curing processes for the epoxy composite compositions (Comp. B-D) are generally carried out as described below. The glass-filled polyetherimide is ULTEM™ 3452, a polyetherimide having 45% glass fiber filler, commercially available from GE Plastics.

Comp. B-D Preparation Procedure

The terms and designations used in the following description include: D.E.N. 425 is an epoxy resin having an EEW of 172, and is commercially available from The Dow Chemical Company; D.E.R. 383 is an epoxy resin having an EEW of 171 and is commercially available from The Dow Chemical Company; “NMA” stands for nadic methyl anhydride, and is commercially available from Polysciences; “ECA100” stands for Epoxy Curing Agent 100, is commercially available from Dixie Chemical, and ECA 100 generally comprises methyltetrahydrophthalic anhydride greater than 80% and tetrahydrophthalic anhydride greater than 10%; “1MI” stands for 1-Methylimidazole, and is commercially available from Aldrich Chemical; SILBOND® W12EST is an epoxy silane treated quartz with D50 grain size of 16 μm, and is commercially available from Quarzwerke.

The requisite amount of filler is dried overnight in a vacuum oven at a temperature of ˜70° C. The epoxy resin which contains anhydride hardeners are separately pre-warmed to ˜60° C. Into a wide mouth plastic container is loaded the designated amount of warm epoxy resin, warm anhydride hardeners, and 1-methyl imidazole which are hand swirled before adding in the warm filler. The container's contents are then mixed on a FlackTek SpeedMixer™ with multiple cycles of ˜1-2 minutes duration from about 800 to about 2000 rpm.

The mixed formulation is loaded into a temperature controlled ˜500 to 1000-mL resin kettle with overhead stirrer using glass stir-shaft and bearing with Teflon® blade along with a vacuum pump and vacuum controller for degassing. A typical degassing profile is performed between about 55° C. and about 75° C. with the following stages being representative: 5 minutes, 80 rpm, 100 Torr; 5 minutes, 80 rpm, 50 Torr; 5 minutes, 80 rpm, 20 Torr with N₂ break to ˜760 Torr; 5 minutes, 80 rpm, 20 Torr with N₂ break to ˜760 Torr; 3 minutes, 80 rpm, 20 Torr; 5 minutes, 120 rpm, 10 Torr; 5 minutes, 180 rpm, 10 Torr; 5 minutes, 80 rpm, 20 Torr; and 5 minutes, 80 rpm, 30 Torr. Depending on the size of the formulation to be degassed, the times at higher vacuums can optionally be increased as well as the use of a higher vacuum of 5 Torr as desired.

Warm, degassed mixture is brought to atmospheric pressure and poured into the warm mold assembly described below. For the specific mold described below some amount between about 350 grams and 450 grams are typically poured into the open side of the mold. The filled mold is placed standing vertically in an 80° C. oven for about 16 hours with temperature subsequently raised and held at 140° C. for a total of 10 hours; then subsequently raised and held at 225° C. for a total of 4 hours; and then slowly cooled to ambient temperature (about 25° C.).

### Mold Assembly

Onto two ˜355 mm square metal plates with angled cuts on one edge is secured on each DUOFOIL™ (˜330 mm×355 mm×˜0.38 mm). A U-spacer bar of ˜3.05 mm thickness and silicone rubber tubing with ˜3.175 mm ID×˜4.75 mm OD (used as gasket) are placed between the plates and the mold is held closed with C-clamps. Mold is pre-warmed in about 65° C. oven prior to its use. The same mold process can be adapted for castings with smaller metal plates as well as the use of thicker U-spacer bars with an appropriate adjustment in the silicone rubber tubing that functions as a gasket.

TABLE 1
Materials Comparison for Wireless-Communications-Tower Component

| COMPONENTS | S1 | Comp. A | Comp. B | Comp. C | Comp. D | Comp. E |
|---|---|---|---|---|---|---|
| Foamed Aluminum (wt %) | 100 | — | — | — | — | — |
| Aluminum* (wt %) | — | 100 | — | — | — | — |
| DER 383 (wt %) | — | — | 20.03 | 18.16 | — | — |
| DEN 425 (wt %) | — | — | — | — | 19.21 | — |
| SILBOND W12EST (wt %) | — | — | 62.5 | 66.0 | 62.5 | — |
| Nadic Methyl anhydride | — | — | 8.64 | 7.83 | 18.10 | — |
| (wt %) | | | | | | |
| Epoxy Curing Agent 100 | — | — | 8.64 | 7.83 | — | — |
| (wt %) | | | | | | |
| 1-methylimidazole (wt %) | — | — | 0.19 | 0.17 | 0.19 | — |
| Glass-filled | — | — | — | — | — | 100 |
| polyetherimide** (wt %) | | | | | | |

PROPERTIES

| | | | | | | |
|---|---|---|---|---|---|---|
| Density (g/cm³) | 0.4 | 2.7 | 1.827 | 1.891 | 1.740 | 1.7 |
| CTE (μm/m · K) | 21 | 23.4 | N/D | N/D | 42 | 19/36 (FD/ |
| | | | | | | TD)*** |
| Thermal Conductivity | 9.3 | 180 | 0.999 | 1.156 | 1.045 | 0.3 |
| (W/m · K) | | | | | | |
| Tg (° C.) (DSC) | — | — | 160 | 156 | 158 | 217 |
| Operating Temperature | >250 | >250 | Up to | Up to | Up to | Up to |
| (° C.) | | | 140 | 140 | 140 | 200 |
| Flame Retardant | Yes | Yes | Yes | Yes | Yes | Yes |
| Platable^{†} | Yes^{††} | Yes | Yes | Yes | Yes | Difficult |

N/D = Not Determined
*Typical 6061 alloy (not measured; data reported obtained from www.efunda.com)
**Properties not measured; data reported obtained from GE product data sheet
***flow direction/transverse direction
^{†}Plating procedure followed according to the description provided in U.S. Provisional patent application Ser. No. 61/557,918
^{††}Foamed aluminum with good skin finish provides a platable surface

As seen in Table 1, the foamed aluminum provides lower coefficients of thermal expansion as compared to thermosets, while maintaining adequate thermal conductivity at greatly reduced densities compared to conventional aluminum.

### Example 2

### Foamed Aluminum Filled with Thermoset Epoxy

Cast a foamed aluminum block having dimensions of 2″×2″×0.5″ in a filled epoxy formulation and cure, according to the following procedure. The epoxy formulation used is DER 332+50/50 nadic methyl anhydride/Epoxy Curing Agent 100 (i.e., MTHPA) with 65 wt % SILBOND 126EST. The foamed aluminum foam is the same as described above in Example 1. After mixing and degassing the epoxy composition as described above, introduce the foamed aluminum into the liquid epoxy mixture in the resin kettle and hold in position using a stirring blade to prevent it from floating. Close the vessel and apply vacuum for 35 minutes as follows to remove the air from the aluminum foam and force the liquid epoxy into the metal pores: 10 torr for 10 min., 5 torr for 5 min., 10 torr for 5 min., 20 torr for 5 min., and 30 torr for 5 min. Then bring the vessel back to atmospheric pressure. Place a 550-mil thick U-spacer into the mold, and pour about ½ of the degassed mixture into the mold assembly (described above), the aluminum foam piece imbibed with epoxy is then positioned in place and the remaining epoxy is poured on the top. Conduct curing at 80° C. for 16 hours, then at 140° C. for 10 hours, and finally completed at 200° C. for 4 hours.

The resulting composite has an average density of 1.65 g/cm³, an average CTE ranging from 23.6 to 29.4 μm/m·K, and a linear, isotropic thermal conductivity of 5.1 W/m·K.

1. An apparatus, comprising:
a wireless-communications-tower component being at least partially formed from a foamed metal,
wherein said foamed metal has a density of less than 2.7 grams per cubic centimeter (“g/cm³”) measured at 25° C.

2. The apparatus of claim 1, wherein the metal of said foamed metal is selected from the group consisting of aluminum, aluminum alloys, magnesium, magnesium alloys, or combinations or two or more thereof.

3. The apparatus of claim 1, wherein said foamed metal has a thermal conductivity of greater than 1 watt per meter Kelvin (“W/m·K”) measured at 25° C., wherein said foamed metal has a linear, isotropic coefficient of thermal expansion (“CTE”) of less than 30 micrometers per meter Kelvin (“μm/m·K”) over a temperature range of −35 to 120° C.

4. The apparatus of claim 1, wherein said foamed metal has a density ranging from 0.1 to 2.0 g/cm³ measured at 25° C., wherein said foamed metal has a relative density ranging from 0.03 to 0.9, wherein said foamed metal has a thermal conductivity ranging from 5 to 150 W/m·K measured at 25° C., wherein said foamed metal has a linear, isotropic CTE ranging from 15 to 30 μm/m·K over a temperature range of −35 to 120° C.

5. The apparatus of claim 1, wherein said foamed metal is a closed-cell foamed metal.

6. The apparatus of claim 1, wherein said foamed metal is an open-cell foamed metal.

7. The apparatus of claim 1, wherein foamed metal presents a surface region, wherein at least a portion of said surface region is either (a) non-foamed metal, or (b) filled with a polymer-based material.

8. The apparatus of claim 1, wherein at least a portion of the void-space pores of said foamed metal contain a polymer-based material.

9. The apparatus of claim 1, wherein said wireless-communications-tower component is selected from the group consisting of a radio frequency (“RF”) cavity filter, a heat sink, an enclosure, a tower-top support accessory, and combinations of two or more thereof.

10. The apparatus of claim 1, wherein said wireless-communications-tower component is an RF cavity filter, wherein at least a portion of said foamed metal is copper and/or silver plated.
